(19) United States
(12) Patent Application Publication
(10) Pub. No.: US 2007/0010186 A1
(43) Pub. Date: Jan. 11, 2007

(54) Coin handling apparatus with means for deflecting non-separated valid coins

(76) Inventors: Jerry Karlson, Lund (SE); Anders Sjostrom, Lund (SE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/440,841

(22) Filed: May 25, 2006

Related U.S. Application Data
(63) Continuation of application No. PCT/SE04/01743, filed on Nov. 29, 2004.

(30) Foreign Application Priority Data
Dec. 2, 2003 (SE) 0303251-3

(51) Int. Cl. G07D 3/00

(52) U.S. Cl. 453/3

(57) ABSTRACT

A coin handling apparatus (1) has a plurality of coin separating stations (113, 114) and a coin sensor (112) positioned along a circular transport path (111) defining a coin transport direction. Each coin separating station comprises a controllable member (115, 116) for separating coins (c₉) individually off said circular transport path in response to at least one coin characteristic detected by said coin sensor. The coin separating stations include at least one station (113, 114) assigned for separation of valid coins, as indicated by said at least one coin characteristic. A deflector (119) is located at said circular transport path (111) and is adapted to deflect any non-separated valid coins (c₁₁), that have passed all of said at least one station (113, 114) assigned for separation of valid coins without actually having been separated off said circular transport path, to an exterior end position (30) which is accessible to a user of said coin handling apparatus (1).

### CROSS-REFERENCE TO RELATED APPLICATIONS

This application is a continuation of international application no. PCT/SE04/001743, filed on Nov. 29, 2004, and designating the United States of America; which application claims the benefit of Swedish patent application no. 0303251-3, filed on Dec. 2, 2003 and U.S. provisional patent application No. 60/527,815, filed on Dec. 8, 2003.

### INCORPORATION BY REFERENCE

The specification and drawings of PCT/SE04/001743, filed on Nov. 29, 2004; Swedish patent application no. 0303251-3, filed on Dec. 2, 2003; and U.S. provisional patent application No. 60/527,815, filed on Dec. 8, 2003 are incorporated herein in their entirety, by this reference.

### TECHNICAL FIELD

The present invention relates to coin handling, and more particularly to a coin handling apparatus of the type that has a plurality of coin separating stations for active separation of coins off a circular transport path in response to at least one coin characteristic detected by a coin sensor.

### BACKGROUND ART

A coin sorter that employs active sorting technology is an example of an apparatus according to the above. Active sorting means that each coin separating station has a controllable movable member, which in response to control signals may be switched between an active position, in which the controllable member interferes with the transport path and will cause a valid coin to be separated off the transport path, and an inactivated position, in which the controllable member is retracted from the transport path and will admit the coin to continue along the transport path past the coin separating station. Commonly, the coin separating stations are implemented as electromagnetic solenoids with movable cores, to which the controllable members are pivotally coupled. Which coin separating station to activate for a certain coin is determined by a coin sensor and a controller, which will detect physical characteristics such as conductivity, permeability, thickness and/or diameter of the coin and in response generate control signals having appropriate voltage or current levels and supply these control signals to the coin separating stations in a timely manner so as to cause activation of the correct station at the correct time (i.e., just before the coin reaches the station in question), without inadvertently separating off any other adjacent coin than the intended one. A coin handling apparatus that uses such active coin separating technology provides great advantages in terms of flexibility and accuracy. For instance, the controller of the apparatus may conveniently be reprogrammed if the apparatus is to be used with another set of coin types (such as a foreign currency, or if the government issues a new type of coin). The apparatus also allows automatic switches between stations/coin bags, when a first bag which is assigned a certain coin denomination or mix of denominations becomes full. Conveniently, the controller of the apparatus may start using another station/coin bag to collect coins of the denomination in question, while the full coin bag may be substituted with an empty one without interrupting the operation of the apparatus.

However, active coin separating technology requires high-precision components and advanced mechanical and electrical design so as to accomplish the active coin separation with sufficient accuracy and reliability. One problem that occurs during real-life operation is that a small fraction of the processed coins are not actually separated off at the appropriate coin separating station, even though they have been identified as valid coins, but instead continue along the transport path past all stations. In the prior art, such non-separated valid coins have been handled by the provision of recirculation means for automatically returning the coins to the transport path and giving them a new opportunity to be separated off at the correct station.

WO 99/33030 discloses a coin sorter with active coin separating technology, where recirculation of any non-separated valid coins is handled by simply letting the coins continue into a new lap around the transport path, so that they again will pass the coin sensor and, ultimately, the coin separating stations. So long as the accuracy of the apparatus is such that only very few coins will actually need recirculation, the approach given in WO 99/33030 is satisfactory. However, as said before, this may require high-precision, advanced components which in turn may pose a cost penalty.

WO 97/07485 discloses an active coin sorting device 8 with a circular transport path and a feedback rail 38 positioned with one end connected to the circular transport path after the last coin separating station 32, 33, 46, 47 and another end disposed adjacently to a coin lifting device or hopper 3, which feeds coins to the coin sorting device 8. Hence, recirculation of non-separated valid coins is accomplished by way of the feedback rail 3, which will cause such coins to be returned to the coin sorting device 8 via the hopper 3.

WO 01/48705 discloses a coin sorter 2 with active coin separating technology similar to the one described in WO 99/33030. Here, however, recirculation is taken care of by way of an accessory device in the form of an inclined conveyor belt 4, which is also used as a mechanism for feeding coins to the coin sorter. Thus, in this sense the arrangement is similar to the solution shown in WO 97/07485.

While all coin handling apparatuses that are shown in the prior art referred to above represent well functioning active coin separating technology, the present inventors have nevertheless realized that an alternative solution to the problem of handling non-separated valid coin can be reached with a less complicated design than in the prior art.

### SUMMARY OF THE INVENTION

An objective of the present invention is thus to provide an alternative solution to the problem of handling non-separated valid coins in a coin handling apparatus that uses active coin separating technology. Particularly, an objective is to provide a solution which requires uncomplicated and inexpensive means for handling non-separated valid coins.

Generally, the above objectives are achieved by a coin handling apparatus according to claim 1.

One aspect of the invention is a coin handling apparatus comprising a plurality of coin separating stations and a coin sensor positioned along a circular transport path defining a coin transport direction, each coin separating station comprising a controllable member for separating coins individually off said circular transport path in response to at least one coin characteristic detected by said coin sensor, wherein said coin separating stations include at least one station assigned for separation of valid coins, as indicated by said at least one coin characteristic. The coin handling apparatus further comprises a deflector located at said circular transport path and adapted to deflect any non-separated valid coins, that have passed all of said at least one station assigned for separation of valid coins without actually having been separated off said circular transport path, to an exterior end position which is accessible to a user of said coin handling apparatus.

Advantageously, the deflector has a stationary location at said circular transport path, and the exterior end position is selected so that any of said non-separated valid coins are prevented from being recirculated to a beginning of the transport path. This has the benefit of eliminating the need for automatic recirculation means. Instead, recirculation of coins that have been deflected by said deflector will require a step of manual intervention, by having the user manually returning the coins, or some of them, to the circular transport path, potentially after manual inspection. Thus, the problem of non-separated valid coins will be solved with a inexpensive mechanical design with fewer components than in the prior art. Moreover, the elimination of automatic recirculation means may allow a more compact apparatus design, and will also allow the apparatus to operate quicker particularly at start and stop of coin processing, thanks to the eliminated recirculation path compared to the prior art.

In one embodiment, the apparatus has a receptacle at said exterior end position, said receptacle being adapted to receive said non-separated valid coins deflected by said deflector.

Such a receptacle will safely receive such non-separated valid coins and facilitate manual inspection and/or intervention for returning the coins to the circular transport path. Thus, the receptacle is advantageously provided at a front side of an apparatus housing of the apparatus.

The apparatus may further have a coin reject station adapted for separation of invalid coins, as indicated by said at least one coin characteristic detected by said coin sensor. In such a case, the receptacle may be adapted to receive also such invalid coins, thereby allowing a further reduction in the number of required components. Alternatively, two different receptacles may be used for non-separated valid coins and for rejected invalid coins.

In one embodiment, the coin reject station is represented by said deflector. In another embodiment it is one of said plurality of coin separating stations.

In one embodiment a detector is positioned to detect the arrival or presence of non-separated valid coins in said receptacle. An indicator may be connected to said detector and be adapted to indicate the arrival or presence of non-separated valid coins in said receptacle. This will be beneficial to the user, who will promptly be alerted of such arrival or presence. Advantageously, such an indicator is located at said front side, adjacently to the receptacle.

Advantageously, the receptacle may furthermore be adapted to receive also coins that have inadvertently fallen off said circular transport path at a position other than said coin separating stations, said deflector and said coin reject station.

In one embodiment, each coin separating station may comprise a solenoid having a movable core, to which the controllable member is pivotally coupled and which is adapted to assume first and second positions depending on said at least one coin characteristic detected by said coin sensor, wherein, in said first position of said core, the controllable member is adapted to separate a valid coin off said circular transport path at said coin separating station and wherein, in said second position of said core, the controllable member is adapted to admit a valid coin to continue along said circular transport path past said coin separating station.

As referred to herein, the term “coin” includes coins that form part of a monetary system for a particular currency, as well as similar objects such as non-monetary coins, markers and tokens.

Other objectives, features and advantages of the present invention will appear from the following detailed disclosure, from the attached dependent claims as well as from the drawings.

### BRIEF DESCRIPTION OF THE DRAWINGS

An exemplifying embodiment of a coin handling apparatus according to the invention will now be described in detail with reference to the accompanying drawings, in which:

FIG. 1 is a perspective view of the coin handling apparatus in its normal operating position, where the apparatus housing is closed,

FIG. 2 is a perspective view of the coin handling apparatus of FIG. 1, with a front part of the apparatus housing withdrawn like a drawer from a rear part of the apparatus housing, wherein an internal coin processing device is revealed,

FIG. 3 is a plan view of the rear part of the apparatus housing and the coin processing device of FIG. 2,

FIG. 4 is a perspective and partly sectional view of the coin handling apparatus, illustrating portions of the coin processing device, wherein input of coins to the coin processing device is prevented by a coin input trapdoor assuming a closed position,

FIG. 5 is a view corresponding to the one shown in FIG. 4, however with the coin input trapdoor in an open position which permits reception of coins in the coin processing device,

FIG. 6a is a view similar to the one shown in FIG. 4, and

FIG. 6b is an enlarged perspective sectional view of one area in the coin processing device.

### DETAILED DISCLOSURE OF AN EXEMPLIFYING EMBODIMENT

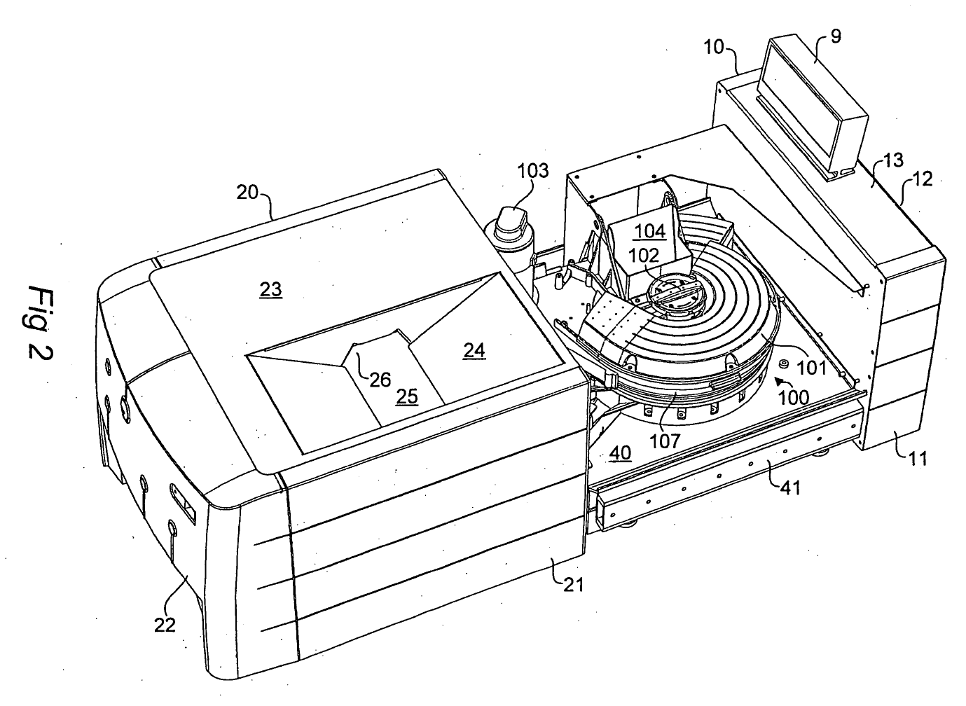

The coin handling apparatus 1 has an apparatus housing or cabinet 2, which comprises a withdrawable front part 20 and a rear part 10, the latter of which also comprises a base 40 for a coin processing device 100. The front part 20 of the apparatus housing 2 is slidably supported by rails 41 (only one of which is shown in FIG. 2) and may thus be withdrawn by a user from the rear part 10 in a convenient manner so as to provide access to the coin processing device 100 and other internal components of the coin handling apparatus 1, for instance when a malfunction is to be remedied by the user.

The rear part 10 of the apparatus housing 2 has a top side 13, lateral sides 11 as well as a back side 12. The top side 13 has a display 9, which advantageously may be removably attached to the apparatus housing 2, thereby allowing the user to instead place the display at a position external to the coin handling apparatus 1. The back side 12 has a plurality of terminals and connectors 14-19, one of which may be a display port for connecting the display 9 to the electronic control circuitry of the coin handling apparatus 1 (a controller 130 included in said electronic control circuit being shown in the drawings). The connectors and terminals 14-19 also include a mains power connection as well as a computer communication interface. The computer communication interface may be a serial interface such as RS232 or USB, a network interface such as Ethernet Twisted Pair (RJ45), or a wireless interface such as Bluetooth. By means of the computer communication interface, the coin handling apparatus 1 may be connected to an external local or remote computer so as to report a result of a completed coin processing transaction to the computer. The computer communication interface may also be used for reporting operational data such as error rates, coin denomination statistics, etc, to the computer. Additionally, the computer communication interface may be used for downloading software and/or settings data to the electronic control circuitry of the coin processing apparatus 1.

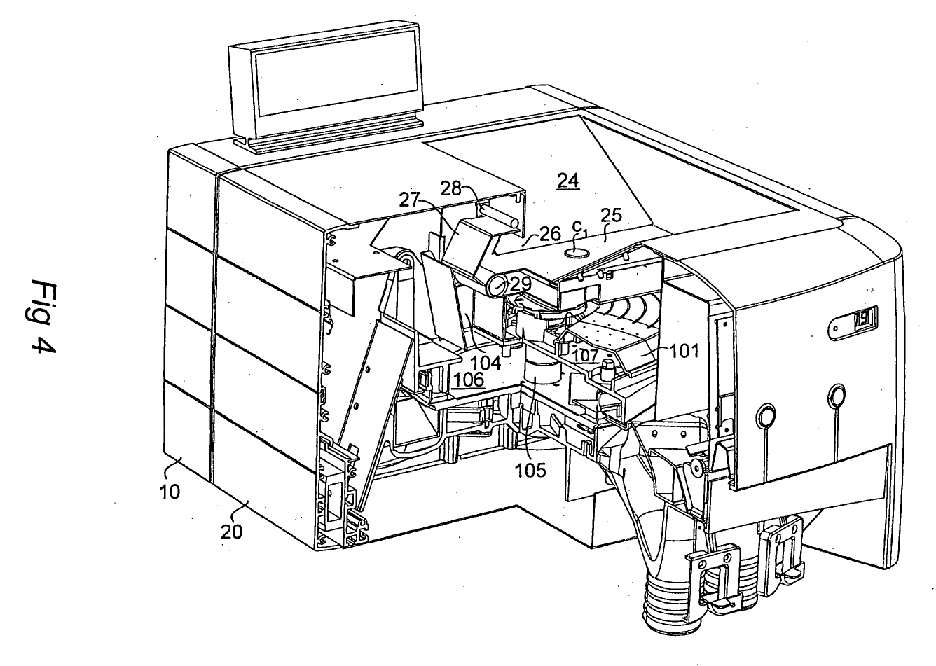

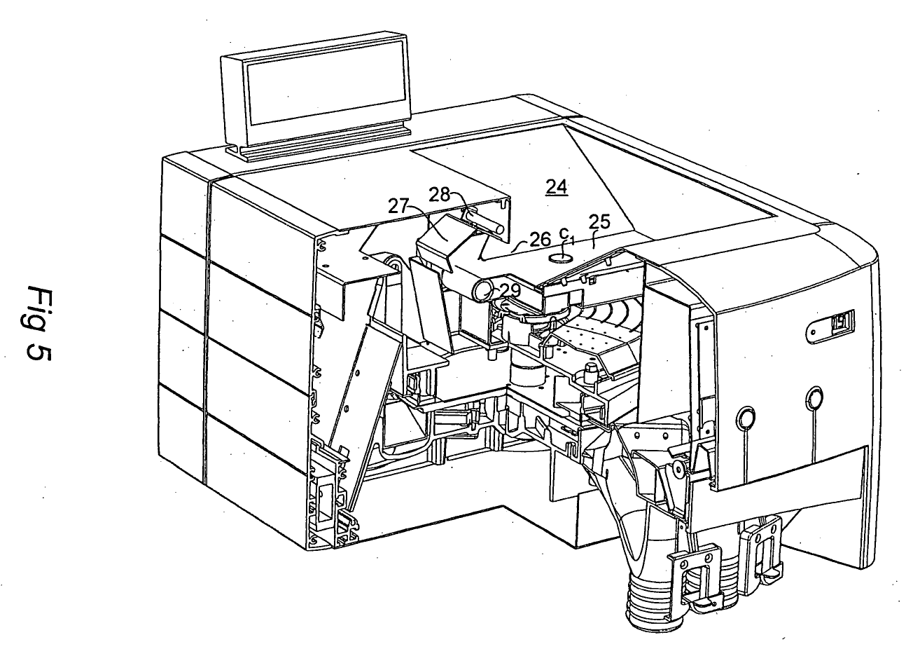

The front part 20 of the apparatus housing 2 has a top side 23, lateral sides 21 and a front side 22. A coin intake 24 or coin input region is formed in the top side 23. At the bottom of the coin intake 24 a conveyor belt 25 is provided for transporting received coins c₁ (FIG. 4) to the interior of the coin handling apparatus 1 through a coin input opening 26. A coin input trapdoor 27 is provided at the coin input opening 26 and is hinged to an actuator 28, by means of which the coin input trapdoor 27 may assume a first, closed position, which is shown in FIG. 4 and in which the received coins c₁ are prevented from entering the interior of the coin handling apparatus 1, and a second, open position, which is shown in FIG. 5 and which permits the received coins c₁ to enter the interior of the coin handling apparatus 1. In more detail, as seen in FIGS. 4 and 5, an angled end portion of the coin input trapdoor 27 will abut against the conveyor belt 25 at one of its drive pulleys 29 in the closed position. In the open position, the actuator 28 will pivot the coin input trapdoor 27 and its angled end away from the conveyor belt 25, as seen in FIG. 5. In this position, the received coins c₁ will pass the coin input opening 26, exit the conveyor belt 25 after having passed the drive pulley 29 and fall down through a coin input channel 104 so as to ultimately land on a rotary disc 106, which is part of the coin processing device 100.

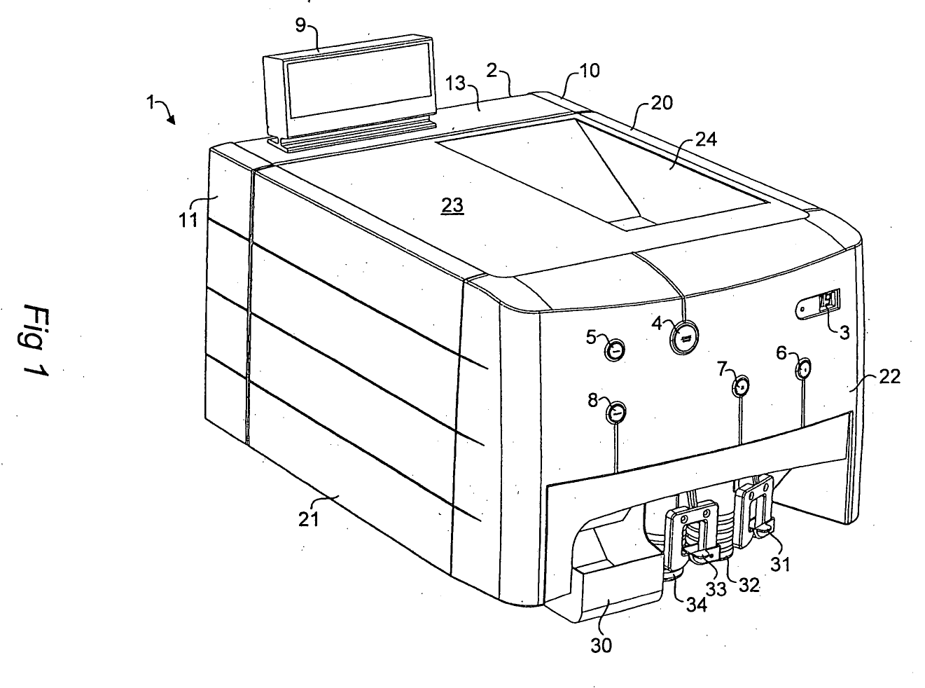

Referring back to FIG. 1, the front side 22 of the front part 21 of the apparatus housing 2 has an LED error indicator 3, a start/stop button 4, a reset button 5, and buttons 6, 7 for selecting between first and second coin bags, in which coins that have been processed by the coin processing device 100 will ultimately be collected through output ducts 32, 34. The coin bags are not shown in FIG. 1, but their attachments are indicated at 31 and 33. In other embodiments, the coin bag buttons 6, 7 may be replaced by visual indicators, which will indicate to the user of the coin handling apparatus 1 which one of the coin bags that is currently used for collecting processed coins, or by combined buttons and indicators. A coin reject indicator 8 is provided adjacently to a receptacle 30 for rejected coins. The reject receptacle 30 is located at an exterior position which is conveniently accessible to the user, and the reject receptacle may further advantageously be removable from the coin handling apparatus 1 so as to facilitate further handling of the coins that have been collected in the reject receptacle 30. The reset button 5 may also be used for commanding transmission of the results of a completed coin processing transaction to an external computer through aforesaid computer communication interface, or for storing the results in an internal memory in the coin handling apparatus 1.

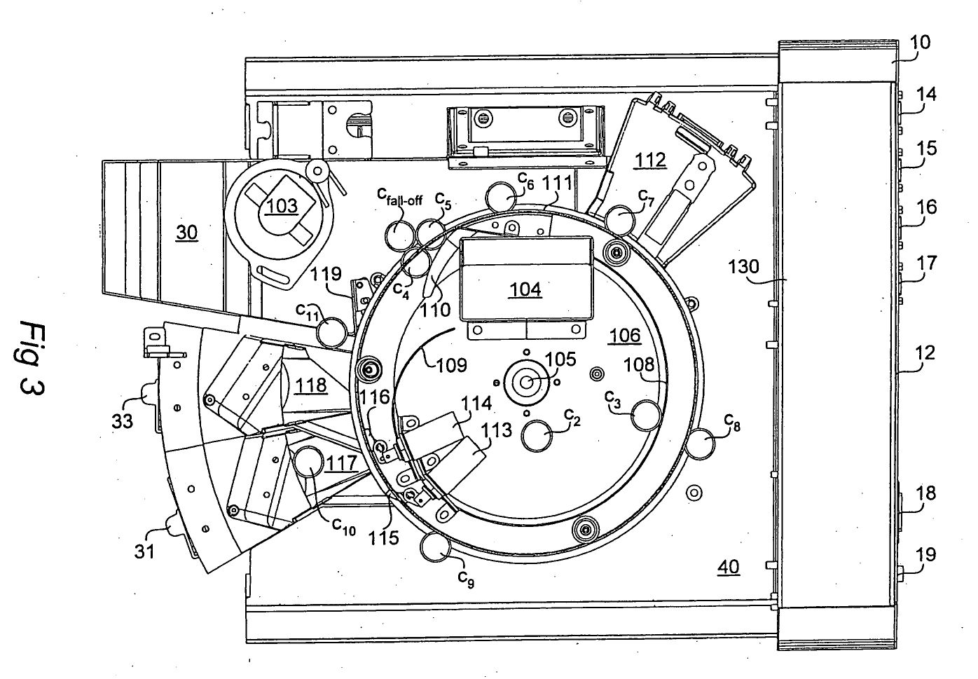

The structure and operation of the coin processing device 100 is generally very similar to that of the coin handling apparatus which is described in aforesaid WO 99/33030, which is fully incorporated herein by reference. Therefore, a lengthy description in greater detail of all the components is not given here; nevertheless, a sufficiently enabling disclosure is given in the following. The coin processing device 100 has a circular coin processing arrangement, which includes two coin separating stations 113, 114 (FIG. 3) arranged along a circular coin transport path 111. The coin transport direction is clockwise in FIG. 3. The number of coin separating stations is considerably less in the exemplifying embodiment of the present invention (i.e., two) than in the embodiment illustrated in aforesaid WO 99/33030 (i.e., ten), the reason being that whereas the apparatus shown in WO 99/33030 is a coin sorter for sorting a plurality of coin denominations, the exemplifying embodiment of the present invention is a coin value counter, which does not act to physically separate different coin denominations into different coin receptacles but merely to identify different coin denominations and calculate an accumulated value for the processed coins. Having two coin separating stations 113, 114 even for a value counting-only coin handling apparatus allows the apparatus to switch between two coin bags when one of the bags has become full of coins, thereby prolonging the operational time between substitution of full coin bags with empty ones. It is to be observed and emphasized that the exact number of coin separating stations is not an essential feature of the present invention.

To accomplish the transport of received coins along the circular transport path 111, the coin processing device 100 has a coin feeding mechanism which comprises a rotary coin feeder 107, which is mounted at its center on an axle 105. An electric motor 103 is coupled to the rotary coin feeder 107 through a drive belt (not shown in the drawings) so as to cause the coin feeder 107 to rotate when the motor 103 is driven. An upper cover 101 protects the coin feeder 107 and the other components of the coin processing device 100 and is secured in position by a lock 102 which is screwed on to the axle 105. By unscrewing the lock 102, the cover 101 may be removed from the coin processing device 100.

When coins c₁ have been received through the coin input channel 104 in the manner described previously, they are received on the surface of the rotary disc 106, as indicated at C₂ in FIG. 3. Upon rotation of the coin feeder 107 by way of the electric motor 103, a resilient rim 111 which is mounted to the lower surface of the feeder 107 comes in frictional engagement with the rotary disc 106, and consequently also the rotary disc 106 will be caused to rotate. As a consequence, the coins on the surface of the rotary disc 106 will be accelerated by centripetal force in a radial direction outwardly and reach a reference edge 108, as seen at c₃ in FIG. 3. The coins will then follow the reference edge 108 and arrive at an end portion 109 of the reference edge 108. In contrast to the preceding portions of the reference edge 108, there is provided an opening between the end portion 109 and the surface of the rotary disc 106, this opening being large enough so as to admit the coins c₃ to slip beneath the end portion 109 and arrive at a position c₄. Here, a deflector knife 110 will push the coins under the resilient rim 111, as seen as c₅, out to a position c₆ in which only a peripheral edge portion of the coins is engaged between the resilient rim 111 and the rotary disc 106. The position referred to as c_{fall-off} is not a normal situation, but it will be referred to in more detail later.

The coins are then transported past a coin sensor or discriminator 112, as seen at c₇ in FIG. 3, where at least one physical characteristic is determined for each coin c₇. Such characteristics may be conductivity, permeability, thickness and/or diameter of the coin c₇. Coin reference data is stored in a memory associated with the controller 130 and serves as a lookup-table that matches different values or value ranges for said coin characteristic(s) to different coin denominations or types. The coin characteristic(s) obtained by the sensor 112 for coin c₇ will be compared to the coin reference data by the controller 130, and in case of a match the denomination of the coin c₇ will be given by said coin reference data, provided that the coin c₂ is a valid coin, as defined by the reference data. Hence, the controller 130 will add the value associated with the denomination of coin c₇ to an accumulated value of all previous coins that have been processed in the current coin processing transaction. The controller 130 will also generate control signals to the appropriate coin separating station 113, 114 so as to actuate a controllable member or deflector 115, 116 thereof, when the coin has traveled along the circular transport path (position c₈) to a position cg near the appropriate coin separating station 113. In the illustrated embodiment, the coin separating stations 113, 114 comprise electromagnetic solenoids, each having a movable core to which the controllable member 115/116 is pivotally coupled.

In FIG. 3, the first coin separating station 113 is illustrated with its controllable member 115 in its activated position, where the deflector interferes with the resilient rim 111 and will force the coin out of engagement with the resilient rim 111, wherein the coin will fall down into a chute 117 and further down the duct 32 into the coin bag attached to the coin bag attachment 31. Furthermore, the second coin separating station 114 is illustrated in FIG. 3 with its controllable member 116 in its inactivated position, retracted from the resilient rim 111 and thus not causing any passing coin to be pushed off the circular transport path and resilient rim 111.

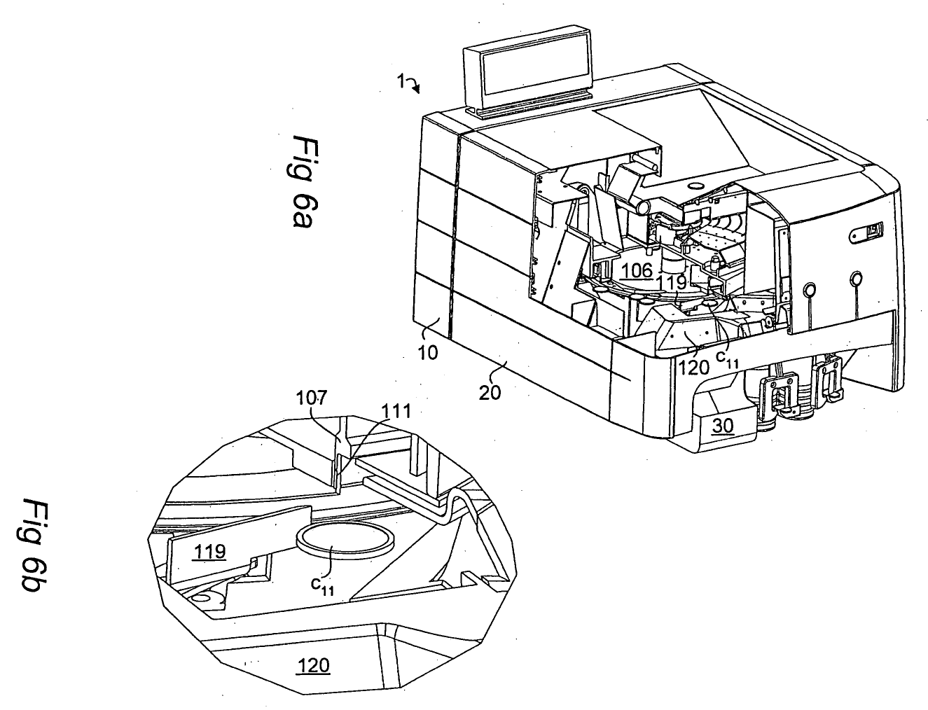

If, in response to the characteristic(s) determined by the sensor 112, the controller 130 decides that a certain coin is not a valid coin, it is handled as a reject coin by the coin processing device 100. In case of a reject coin, both coin separating stations 113, 114 will remain inactivated when the coin passes them, wherein the coin will arrive at a position c₁₁ where it hits a deflector 119 in the form of a knife-shaped metal plate. As seen in FIGS. 3 and 6a/b, the deflector 119 is mounted at a position after the last coin separating station 114 along the circular transport path 111, with one end close enough to the perimeter of the coin feeder 107/rotary disc 106 so as to deflect the coin c₁₁ from the circular transport path into a reject channel 120. After having fallen through the reject channel 120, the coin c₁₁ will be received and collected in the reject receptacle 30. Thus, in contrast to prior-art active, circular coin processing devices, the illustrated embodiment uses a stationary mechanical deflector 119 to deflect reject coins instead of one of the controllable coin separating stations. In addition to this, the deflector 119 of the illustrated embodiment also serves a purpose for deflecting any valid coin, which has been positively identified by the coin sensor 112 and the controller 130 as a valid coin and thus should have been separated by any of the coin separating stations 113, 114 but in fact has not been separated and arrives at position c₁₁ after the last coin separating station 114. The reason for this may be a mismatch in timing of the control signals from the controller 130 to the coin separating stations 113, 114, so that the controllable member 115, 116 is activated a bit too late and the valid coin will “escape” the controllable member. Another situation is when the coin bag of the currently used coin separating station 113, 114 has become full and a switch is to be done to the coin bag of the other coin separating station 114, 113. When this happens, the coin input trapdoor 27 is preferably closed so as to prevent further coins c₁ from entering the coin processing device 100 until the switch to the new coin bag has been completed, but nevertheless there may still be coins c₂-c₈ in the coin processing device 100 that have not yet passed the coin separating stations 113, 114. Thus, these stations are kept inactive by the controller during the switch of coin bags, wherein such valid but non-separated coins will be deflected by the deflector 119 at c₁₁ into the reject receptacle 30.

The coin input trapdoor 27 is automatically closed by the controller 130 and the actuator 28, and the operation of the belt 25 is suspended, in the following situations:

When an error condition has been detected in the coin processing device 100, such as a coin jam.

When a calibration of the sensor 112 is to be performed. To allow optimum coin discriminating accuracy, certain parameters related to aforesaid coin reference data are regularly updated by obtaining “no-coin” or idle measurement values by the coin sensor 112 when no coin is present along the transport path. Thanks the provision of the deflector 119 in combination with the coin input trapdoor 27, a no-coin situation may be quickly reached also during an ongoing coin processing transaction. When the calibration is to be performed, the coin input trapdoor 27 is closed, and coins yet to be processed will remain in the coin input region 24, whereas existing coins within the coin processing device will be rapidly processed by the stations 113, 144 or deflector 119.

In addition to the above, the coin input trapdoor 27 is also kept closed at start-up of the apparatus so as to allow it to reach a correct operating temperature, etc.

The reject receptacle 30 is used in the illustrated embodiment also for a third category of coins, referred to as “fall-off” coins. Such a fall-off coin is illustrated at c_{fall-off} in FIG. 3. A fall-off coin is a coin that for some reason loses engagement with the resilient rim 111 prior to the intended destination (coin separating station 113, 114, deflector 119). One example why this may happen is shown in FIG. 3; two adjacent coins c₄ and c₅ do not leave enough space for the coin c_{fall-off} to engage with the resilient rim 111. Instead, this coin will be pushed out of contact with the resilient rim 111 by the knife 110 and coin c₄, c₅ into the channel 120 and reject receptacle 30.

The invention has been described above with reference to an exemplifying embodiment. However, as is readily appreciated by a person skilled in the art, other embodiments than the one disclosed above are equally possible within the scope of the invention as defined by the appended patent claims. For instance, the number of coin separating stations may be considerably more than two, wherein such an embodiment may be a real coin sorting apparatus rather than a coin value counting apparatus. The design and operation of the coin separating stations may be different than in the illustrated embodiment. Rather than using electromechanical solenoids, the coin separating stations may operate pneumatically or hydraulically under electrical or optical control. Furthermore, the design of the deflector 119 may be varied so long as it satisfies the functional requirements set out above.

1. A coin handling apparatus comprising a plurality of coin separating stations and a coin sensor positioned along a circular transport path defining a coin transport direction, each coin separating station comprising a controllable member for separating coins individually off said circular transport path in response to at least one coin characteristic detected by said coin sensor, wherein said coin separating stations include at least one station assigned for separation of valid coins, as indicated by said at least one coin characteristic, the coin handling apparatus further comprising a coin reject station adapted for separation of invalid coins, as indicated by said at least one coin characteristic detected by said coin sensor,
wherein the coin reject station is a deflector located after a last coin separating station at said circular transport path and being further adapted to deflect any non-separated valid coins, that have passed all of said at least one station assigned for separation of valid coins without actually having been separated off said circular transport path, to an exterior end position which is accessible to a user of said coin handling apparatus, and
wherein the apparatus further comprises a receptacle at said exterior end position, said receptacle being adapted to receive said non-separated valid coins and said invalid coins deflected by said deflector.

2. An apparatus according to claim 1, wherein said deflector has a stationary location at said circular transport path and wherein said exterior end position is selected so that any of said non-separated valid coins and invalid coins are prevented from being recirculated to a beginning of the transport path without a step of manual intervention.

3. An apparatus according to claim 2, further comprising a detector positioned to detect the arrival or presence of non-separated valid coins and invalid coins in said receptacle.

4. An apparatus according to claim 3, further comprising an indicator connected to said detector and adapted to indicate the arrival or presence of non-separated valid coins and invalid coins in said receptacle.

5. An apparatus according to claim 3, further comprising an apparatus housing having a front side, said receptacle being located at said front side.

6. An apparatus according to claim 4, wherein said indicator is located at said front side.

7. An apparatus according to claim 3, wherein said receptacle is adapted to receive also coins that have inadvertently fallen off said circular transport path at a position other than said coin separating stations.

8. An apparatus according to claim 1, each coin separating station comprising a solenoid having a movable core, to which the controllable member is pivotally coupled and which is adapted to assume first and second positions depending on said at least one coin characteristic detected by said coin sensor, wherein, in said first position of said core, the controllable member is adapted to separate a valid coin off said circular transport path at said coin separating station and wherein, in said second position of said core, the controllable member is adapted to admit a valid coin to continue along said circular transport path past said coin separating station.
